(19) United States
(12) Patent Application Publication
(10) Pub. No.: US 2024/0089820 A1
(43) Pub. Date: Mar. 14, 2024

(54) METHOD AND USER EQUIPMENT (UE) FOR PROVISIONING UE PROCEDURES FOR NETWORK SLICING

(71) Applicant: Samsung Electronics Co., Ltd., Suwon-si Gyeonggi-do (KR)

(72) Inventors: Jajohn Mathew MATTAM, Bangalore (IN); Vinay Kumar SHRIVASTAVA, Bangalore (IN)

(21) Appl. No.: 18/272,494

(22) PCT Filed: Jan. 14, 2022
(86) PCT No.: PCT/KR2022/000771

§ 371 Date: Jul. 14, 2023

(30) Foreign Application Priority Data
Jan. 15, 2021 (IN) 202141001868
Dec. 16, 2021 (IN) 2021 41001868

(51) Int. Cl. H04W 36/14; H04W 48/16

(52) U.S. Cl. CPC H04W 36/14; H04W 48/16

(57) ABSTRACT

The present disclosure relates to a method and a User Equipment (UE) for Radio Access Network (RAN) slicing in wireless. A method for a user equipment (UE) is provided. The method includes receiving, from a base station (BS), network slice information on a plurality of network slices supported by a serving cell of the UE and at least one neighbor cell from a plurality of cells via a broadcasted system information block (SIB); identifying a priority order of the plurality of network slices based on the network slice information; selecting a cell based on the priority order of the plurality of network slices; and camping on the selected cell.

### TECHNICAL FIELD

The present disclosure relates to a wireless network and in particular, relates to a method and a User Equipment (UE) for Radio Access Network (RAN) slicing in wireless communication system.

### BACKGROUND ART

To meet the demand for wireless data traffic having increased since deployment of 4th generation (4G) communication systems, efforts have been made to develop an improved 5th generation (5G) or pre-5G communication system. The 5G or pre-5G communication system is also called a ‘beyond 4G network’ or a ‘post long term evolution (LTE) system’. The 5G communication system is considered to be implemented in higher frequency (mmWave) bands, e.g., 60 GHz bands, so as to accomplish higher data rates. To decrease propagation loss of the radio waves and increase the transmission distance, beamforming, massive multiple-input multiple-output (MIMO), full dimensional MIMO (FD-MIMO), array antenna, analog beamforming, and large scale antenna techniques are discussed with respect to 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like. In the 5G system, hybrid frequency shift keying (FSK) and Feher's quadrature amplitude modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, MTC, and M2M communication may be implemented by beamforming, MIMO, and array antennas. Application of a cloud RAN as the above-described big data processing technology may also be considered to be as an example of convergence between the 5G technology and the IoT technology.

### DISCLOSURE OF INVENTION

### Solution to Problem

A method for a user equipment (UE) is provided. The method includes receiving, from a base station (BS), network slice information on a plurality of network slices supported by a serving cell of the UE and at least one neighbor cell from a plurality of cells via a broadcasted system information block (SIB); identifying a priority order of the plurality of network slices based on the network slice information; selecting a cell based on the priority order of the plurality of network slices; and camping on the selected cell.

### Advantageous Effects of Invention

According to the embodiments of the present invention, a method and a UE for provisioning UE procedures for network slicing in a wireless communication system.

### BRIEF DESCRIPTION OF DRAWINGS

This embodiment is illustrated in the accompanying drawings, throughout which like reference letters indicate corresponding parts in the various figures. The embodiments herein will be better understood from the following description with reference to the drawings.

FIG. 1 illustrates a mobility scenario when a UE is in a connected mode.

FIG. 2 is an overview of a wireless network for UE procedures for network slicing, according to an embodiment as disclosed herein.

FIG. 3 shows various hardware components of a UE, according to an embodiment as disclosed herein.

FIG. 4 shows various hardware components of a network entity, according to an embodiment as disclosed herein.

FIG. 5 is a flow chart illustrating a method, implemented by the UE, for provisioning the UE procedures for the network slicing, according to an embodiment as disclosed herein.

FIG. 6 is a flow chart illustrating a method, implemented by the network entity, for provisioning the UE procedures for the network slicing, according to an embodiment as disclosed herein.

FIG. 7 illustrates a mobility scenario when the UE is a connected mode, according to the embodiments as disclosed herein.

FIG. 8 illustrates a cell selection in the network.

FIG. 9 illustrates a proposed cell selection in the wireless network, according to the embodiments as disclosed herein.

FIG. 10 illustrates a cell reselection in the wireless network.

FIG. 11 illustrates cell reselection in the wireless network, according to the embodiments as disclosed herein.

FIG. 12 is a block diagram of a configuration of a base station, according to the embodiment as disclosed herein.

FIG. 13 is a block diagram showing a structure of a terminal, according to an embodiments as disclosed herein.

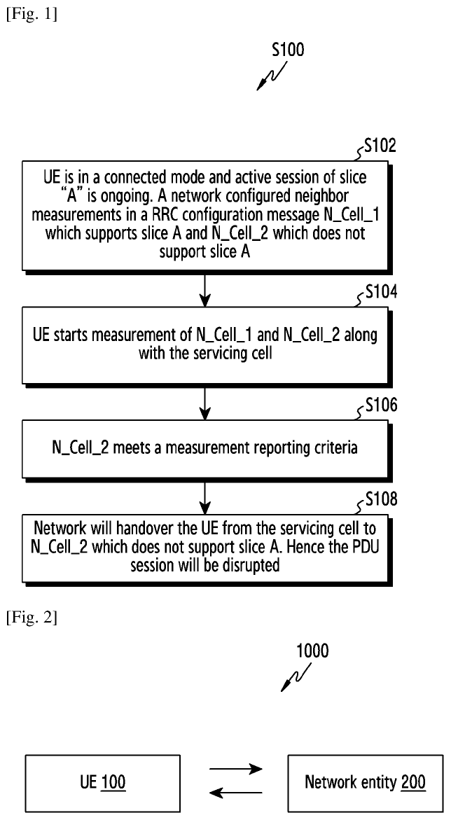

### BEST MODE FOR CARRYING OUT THE INVENTION

A method for a user equipment (UE) is provided. The method includes receiving, from a base station (BS), network slice information on a plurality of network slices supported by a serving cell of the UE and at least one neighbor cell from a plurality of cells via a broadcasted system information block (SIB); identifying a priority order of the plurality of network slices based on the network slice information; selecting a cell based on the priority order of the plurality of network slices; and camping on the selected cell.

In one embodiment, the network slice information includes at least one of a Network Slice Selection Assistance Information (NSSAI) list and NSSAI group lists.

In one embodiment, if the network slice information includes the list of NSSAI, mapping the NSSAI to each of the serving cell and the at least one neighbor cell based on a bit map with respect to each of the serving cell and at least one neighbor cell, and the bit map is of a size up to number of NSSAIs included in the NSSAI list.

In one embodiment, if the network slice information includes the NSSAI group lists, mapping a NSSAI group to each of the serving cell and the at least one neighbor cell based on an Information Element (IE), and the NSSAI group includes NSSAIs supporting the each of the serving cell and the at least one neighbor cell.

In one embodiment, the method includes receiving, from the base station, a dedicated network slice information via a Radio resource control (RRC) Release message; and identifying the priority order of the plurality of network slices based on the dedicated network slice information while a timer is running.

In one embodiment, the method includes identifying the priority order of the plurality of network slices based on the network slice information after expiry of the timer.

In one embodiment, the method includes transmitting, to the base station, a UE assistance information including information on interested network slice via a RRC message, and the network slice information is generated based on the UE assistance information.

In one embodiment, the selecting of the cell based on the priority order of the plurality of network slices comprises identifying at least one cell from the plurality of cells satisfying criteria for the camping; and selecting the at least one cell for the camping based on at least one of previous registration, previous access to cells, cell supporting highest priority slice, cells supporting a maximum number of slices, strongest cell supporting at least one required slice, and strongest cell supporting at least one higher priority required slice.

A user equipment (UE) is provided. The UE comprises: a transceiver; and at least one controller coupled with the transceiver configured to: receive, from a base station (BS), network slice information on a plurality of network slices supported by a serving cell of the UE and at least one neighbor cell from a plurality of cells via a broadcasted system information block (SIB), identify a priority order of the plurality of network slices based on the network slice information, select a cell based on the priority order of the plurality of network slices, and camp on the selected cell.

In one embodiment, the network slice information includes at least one of a Network Slice Selection Assistance Information (NSSAI) list and NSSAI group lists.

In one embodiment, the controller is further configured to: if the network slice information includes the list of NSSAI, map the NSSAI to each of the serving cell and the at least one neighbor cell based on a bit map with respect to each of the serving cell and at least one neighbor cell, and wherein the bit map is of a size up to number of NSSAIs included in the NSSAI list.

In one embodiment, the controller is further configured to: if the network slice information includes the NSSAI group lists, mapping a NSSAI group to each of the serving cell and the at least one neighbor cell based on an Information Element (IE), and the NSSAI group includes NSSAIs supporting the each of the serving cell and the at least one neighbor cell.

In one embodiment, the controller is further configured to: receive, from the base station, a dedicated network slice information via a Radio resource control (RRC) Release message, and identify the priority order of the plurality of network slices based on the dedicated network slice information while a timer is running.

In one embodiment, the controller is further configured to: identify the priority order of the plurality of network slices based on the network slice information after expiry of the timer.

In one embodiment, the controller is further configured to: transmit, to the base station, a UE assistance information including information on interested network slice via a RRC message, and the network slice information is generated based on the UE assistance information.

Accordingly, the embodiment herein is to provide a method for provisioning UE procedures for network slicing. The method includes receiving, by a UE, network slice information of a plurality of network slices supported by a serving cell from a plurality of cells of the UE and at least one neighbor cell from the plurality of cells. In an embodiment, the method includes reordering the plurality of cells based on the network slice information supported by the serving cell and the at least one neighbor cell, and measuring at least one cell of the plurality of reordered cells based on a priority order of the plurality of cells, and sending a measurement report corresponding to the at least one cell to the serving cell. In another embodiment, the method includes determining a priority order of the network slices based on the network slice information supported by the plurality of cells, and selecting at least one cell from the plurality of cells for camping based on the priority order of the network slices. In another embodiment, the method includes determining a priority order of the network slices based on the network slice information supported by the serving cell and the at least one neighbor cell, and reselecting at least one cell from the plurality of cells based on the priority order of the network slices.

In an embodiment, the network slice information is received in at least one of a SIB based broadcast and signaling through a RRC Release message.

In an embodiment, the network slice information is received by the UE in one of a list of Network Slice Selection Assistance Information (NSSAI) and a group of NSSAI lists.

In an embodiment, the method includes mapping, by the UE, the NSSAI to each of the serving cell and the at least one neighbor cell using at least one of ‘a bit map with respect to each of the serving cell and at least one neighbor cell when the network slice information is received in the list of NSSAI’ and ‘an Information Element (IE) with each of the serving cell and at least one neighbour cell to the supported group of slices when the network slice information is received in the group of NSSAI lists. Further, the method includes determining, by the UE, that the mapping of the serving cell and at least one neighbor cell is associated with frequency information shared by the serving cell and the at least one neighbor cell, where the frequency information comprises an allowed list cells from the plurality of cells and blocked list cells from the plurality of cells. Further, the method includes determining, by the UE, whether the serving cell and at least one neighbor cell belongs to the allowed list cells or the blocked list cells. Further, the method includes detecting, by the UE, the serving cell and the at least one neighbor cell supports the network slice information in response to determining that the serving cell and the at least one neighbor cell belongs to the allowed list cells. Further, the method includes detecting, by the UE, the serving cell and the at least one neighbor cell supports the network slice information in response to determining that the serving cell and the at least one neighbor cell belongs to the blocked list cells.

In an embodiment, the bit map can be of a size up to number of NSSAIs included in the list of NSSAIs.

In an embodiment, the IE comprises each of the serving cell and the at least one neighbor cell mapped to the group of NSSAI lists.

In an embodiment, the method includes utilizing by the UE the RRC Release message based at least one of slice information and dedicated priority information until a timer T320 is running wherein when the network slice information is available from both the SIB based broadcast and the RRC Release message, and utilizing by the UE the SIB broadcast based slice information in response to detecting expiry of the T320 expiry.

In an embodiment, the method includes determining the priority order of the plurality of cells based on at least one cell from the plurality of cells supporting a maximum number of ongoing network slices and at least one cell from the plurality of cells supporting a maximum number of interested slices.

In an embodiment, sending the measurement report corresponding to the at least one cell to the serving cell includes detecting, by the UE, whether the at least one neighbor cell from the plurality of cells meets a neighbor cell reporting criteria, detecting, by the UE, whether multiple neighbor cells are meeting a multiple neighbor cells reporting criteria in response to detecting that the at least one neighbor cell from the plurality of cells meets a neighbor cell reporting criteria; and performing, by the UE, at least one of: prioritizing the plurality of network slices supporting an ongoing network slices in response to determining that multiple neighbor cells are meeting the multiple neighbor cells reporting criteria, splitting the measurement report, and sending the measurement report associated with the at least one cell to the serving cell; and sending the measurement report corresponding to the at least one cell to the serving cell in response to determining that multiple neighbor cells are not meeting the multiple neighbor cells reporting criteria.

In an embodiment, selecting the at least one cell from the plurality of cells based on the priority order of the network slices includes determining a list of cells from the plurality of cells meeting a Scriteria, and selecting the at least one cell from the list of cells for camping based on at least one of previous registration, previous access to cells, cell supporting highest priority slice, cells supporting a maximum number of slices, strongest cell supporting at least one required slice, and strongest cell supporting at least one higher priority required slice.

In an embodiment, reselecting the at least one cell from the plurality of cells based on the priority order of the network slices includes reading information of the at least one neighbor cell from the plurality of cells, determining whether the at least one neighbor cell having a higher priority compared to the serving cell, a lower priority compared to the serving cell, and an equal priority compared to the serving cell; and performing one of: reordering priority of the plurality of cells having the higher priority based on the priority order of the network slices defined by the UE in response to determining that the at least one neighbor cell having the higher priority compared to the serving cell, and reselecting the at least one cell from the plurality of reordered cells, reordering priority of the plurality of cells having the lower priority based on the priority order of the network slices defined by the UE in response to determining that the at least one neighbor cell having the lower priority compared to the serving cell, and reselecting the at least one cell from the plurality of reordered cells, and reordering priority of the plurality of cells having the equal priority based on the priority order of the network slices defined by the UE in response to determining that the at least one neighbor cell having the equal priority compared to the serving cell, and reselecting the at least one cell from the plurality of reordered cells.

In an embodiment, receiving, by the UE, the network slice information of the plurality of network slices supported by a serving cell from a plurality of cells of the UE and at least one neighbor cell from the plurality of cells includes sending, by the UE, UE assistance information comprises interested or desired slices details to a network entity through a RRC message, and receiving, by the UE, a slice assistance configuration in a RRC reconfiguration from the network entity based on that UE needs to control and provide the slice assistance to the network, wherein the slice assistance configuration comprises network slice information and at least one of priority of slices or cells, a slice assistance periodic timer, a slice assistance prohibit timer, one or more triggers or events.

Accordingly, the embodiment herein is to provide a method for provisioning UE procedures for network slicing. The method includes configuring by network entity a slice assistance configuration for the UE, sending by the network entity the slice assistance configuration in a RRC reconfiguration to the UE and receiving by the network entity UE assistance information comprises interested or desired slices details from the UE (100) through a RRC message. The slice assistance configuration comprises network slice information and at least one of priority of slices or cells, a slice assistance periodic timer, a slice assistance prohibit timer, one or more triggers or events based on that the UE (100) needs to control and provide the slice assistance to the network entity.

Accordingly, the embodiment herein is to provide a UE for provisioning UE procedures for network slicing. The UE includes a network slice based procedure controller connected to a memory and a processor. The network slice based procedure controller is configured to receive network slice information of a plurality of network slices supported by a serving cell from a plurality of cells of the UE and at least one neighbor cell from the plurality of cells. In an embodiment, the network slice based procedure controller is configured to reorder the plurality of cells based on the network slice information supported by the serving cell and the at least one neighbor cell, and measure at least one cell of the plurality of reordered cells based on a priority order of the plurality of cells, and send a measurement report corresponding to the at least one cell to the serving cell. In another embodiment, the network slice based procedure controller is configured to determine a priority order of the network slices based on the network slice information supported by the plurality of cells, and select at least one cell from the plurality of cells for camping based on the priority order of the network slices. In an embodiment, the network slice based procedure controller is configured to determine a priority order of the network slices based on the network slice information supported by the serving cell and the at least one neighbor cell, and reselect at least one cell from the plurality of cells based on the priority order of the network slices.

Accordingly, the embodiment herein is to provide a network entity for provisioning UE procedures for network slicing. The network entity includes a network slice based procedure controller connected to a memory and a processor. The network slice based procedure controller is configured to configure a slice assistance configuration for the UE (100), send the slice assistance configuration in a RRC reconfiguration to the UE (100), and receive UE assistance information comprises interested or desired slices details from the UE (100) through a RRC message.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### MODE FOR THE INVENTION

Before undertaking the description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Definitions for other certain words and phrases are provided throughout this patent document. Those of ordinary skill in the art should understand that in many if not most instances, such definitions apply to prior as well as future uses of such defined words and phrases.

In general, with the introduction of a Radio Access Network (RAN) slicing and slice information in a system information block (SIB), there can be multiple issues with the existing User Equipment (UE) procedures and specification references. Mobility in a connected mode, payload size of the SIB when slice information is added, priority based reselection and cell selections are the aspects which needs to be addressed. The major concern of including slice information in the SIB is the payload size. With the addition of supported slice(s) for a serving cell and neighbor cells, the size of SIB is going to be large.

Further, the existing reselection procedure determines only a priority of frequency set by a network entity. This may not give cell specific prioritization and consideration for the preferred slices. As the slice priority depends on each UE, the network entity may not be able to prioritize the slices/cells based on the supported slices in a cell. Hence, just giving frequency priority may not serve the purpose when slice information is included in the SIB. Current cell selection procedure does not consider the slice information broadcasted.

The embodiment herein is to provide a method for provisioning UE procedures for network slicing. The method includes receiving, by a UE, network slice information of a plurality of network slices supported by a serving cell from a plurality of cells of the UE and at least one neighbor cell from the plurality of cells. In an embodiment, the method includes reordering the plurality of cells based on the network slice information supported by the serving cell and the at least one neighbor cell, and measuring at least one cell of the plurality of reordered cells based on a priority order of the plurality of cells, and sending a measurement report corresponding to the at least one cell to the serving cell. In another embodiment, the method includes determining a priority order of the network slices based on the network slice information supported by the plurality of cells, and selecting at least one cell from the plurality of cells for camping based on the priority order of the network slices. In another embodiment, the method includes determining a priority order of the network slices based on the network slice information supported by the serving cell and the at least one neighbor cell, and reselecting at least one cell from the plurality of cells based on the priority order of the network slices.

In the conventional methods and systems, the UE is unaware of the slices supported on different cells or frequencies, which prevents the UE to (re)select to the cell or frequency supporting the intended slice. The dedicated priorities would not be available to the UE prior to a first RRC connection establishment and only remain valid before T320 expires upon entering an idle mode. In addition, dedicated priorities are discarded each time when UE entering connected mode and need to be configured again before UE leaving connected mode.

Further, an operator may require different frequency priority configurations for the specific slice in different areas; however the dedicated priority always overwrites the broadcast priorities if configured.

If the serving cell is unable to support the requested slices for the subsequent access of the UE, the serving cell may bring on handover or rejection of access request. That may increase control plane signaling overhead as well as long control plane latency for the UE to access the network.

The proposed method can be used to provide legacy priority via a Radio Resource Control (RRC) release message. Further, the proposed method can be used to provide slice related information, the slice information of serving cell and neighboring cells are provided in the system information block (SIB) or a RRC release message. Further, the UE receives the slice assistance configuration in the RRC reconfiguration from the network entity based on that UE needs to control and provide the slice assistance to the network entity. The slice assistance configuration includes network slice information and the priority of slices or cells, a slice assistance periodic timer, slice assistance prohibit timer, one or more triggers or events. This results in reducing the resource wastage.

The embodiments of the present invention provide a method and a UE for provisioning UE procedures for network slicing in a 5th Generation (5G). In an embodiment, a UE receives the slice assistance configuration in a RRC reconfiguration from a network entity based on that the UE needs to control and provide the slice assistance to the network entity. The slice assistance configuration includes network slice information and the priority of slices or cells, a slice assistance periodic timer, slice assistance prohibit timer, one or more triggers or events. This results in reducing the resource wastage. In an embodiment, a UE maintains a priority of slices based on an interest and support. When neighbor cells are configured, the UE may check the availability of required slices in the cells and prioritize the neighbor cells accordingly. In order to check and apply the list of supported cells, the UE may prioritize the interested slices in the decreasing order and use the details/list of accepted slices when camped to the same cell earlier. Further, to prioritize a cell, the UE may prioritize the cells based on the priority of supported slices and prioritize the cells in the order of maximum number of supporting slices.

Referring now to the drawings and more particularly to FIGS. 2 through 7, 9 and 11 where similar reference characters denote corresponding features consistently throughout the figures, there are shown preferred embodiments.

FIG. 2 is an overview of a wireless network (1000) for UE procedures for network slicing, according to an embodiment as disclosed herein. In an embodiment, the wireless network (1000) includes a UE (100) and a network entity (200). The wireless network (1000) can be, for example, but not limited to a 5G network, a 6G network and an O-RAN network. The UE (100) can be, for example, but not limited to a laptop, a desktop computer, a notebook, a relay device, a Device-to-Device (D2D) device, a vehicle to everything (V2X) device, a smartphone, a tablet, an immersive device, and an internet of things (IoT) device.

The UE (100) receives network slice information of a plurality of network slices supported by a serving cell from a plurality of cells of the UE (100) and one or more neighbor cell from the plurality of cells. In an embodiment, the UE (100) sends UE assistance information comprising interested or desired slices details to the network entity (200) through a RRC message. The network entity (200) configures the slice assistance configuration based on the interested or desired slices requested by the network entity (200) and sends the slice assistance configuration in the RRC reconfiguration to the UE (100). Further, the UE (100) receives the slice assistance configuration in the RRC reconfiguration from the network entity (200) based on that UE (100) needs to control and provide the slice assistance to the network entity (200). The slice assistance configuration includes network slice information and the priority of slices or cells, a slice assistance periodic timer, slice assistance prohibit timer, one or more triggers or events.

In an embodiment, the network slice information is received in a SIB based broadcast and a signaling through the RRC release message. In another embodiment, the network slice information is received by the UE (100) in one of a list of Network Slice Selection Assistance Information (NSSAI) and a group of NSSAI lists.

In an embodiment, the UE (100) reorders the plurality of cells based on the network slice information supported by the serving cell and the neighbor cell. Further, the UE (100) measures a cell of the plurality of reordered cells based on a priority order of the plurality of cells and sends a measurement report corresponding to the cell to the serving cell.

In an embodiment, the UE (100) detects whether the neighbor cell from the plurality of cells meets a neighbor cell reporting criteria. If the neighbor cell from the plurality of cells meets the neighbor cell reporting criteria then, the UE (100) detects whether multiple neighbor cells are meeting the multiple neighbor cells reporting criteria. In an embodiment, if multiple neighbor cells are meeting the multiple neighbor cells reporting criteria then, the UE (100) prioritizes the plurality of network slices supporting an ongoing network slices, splits the measurement report, and sends the measurement report associated with the at least one cell to the serving cell. Alternately, if multiple neighbor cells are not meeting the multiple neighbor cells reporting criteria then, the UE (100) sends the measurement report corresponding to the cell to the serving cell.

In another embodiment, the UE (100) determines a priority order of the network slices based on the network slice information supported by the plurality of cells and select the cell from the plurality of cells for camping based on the priority order of the network slices. In an embodiment, the UE (100) determines the list of cells from the plurality of cells meeting the Scriteria. Further, the UE (100) selects the cell from the list of cells for camping based on at least one of previous registration, previous access to cells, cell supporting highest priority slice, cells supporting a maximum number of slices, strongest cell supporting at least one required slice, and strongest cell supporting at least one higher priority required slice.

In another embodiment, the UE (100) determines a priority order of the network slices based on the network slice information supported by the serving cell and the neighbor cell. Further, the UE (100) reselects the cell from the plurality of cells based on the priority order of the network slices.

In an embodiment, the UE (100) reads information of the neighbor cell from the plurality of cells and determines whether the neighbor cell having a higher priority compared to the serving cell, a lower priority compared to the serving cell, and an equal priority compared to the serving cell.

If the neighbor cell having the higher priority compared to the serving cell then, the UE (100) reorders priority of the plurality of cells having the higher priority based on the priority order of the network slices defined by the UE (100) and reselects the cell from the plurality of reordered cells.

If the neighbor cell having the lower priority compared to the serving cell then, the UE (100) reorders the priority of the plurality of cells having the lower priority based on the priority order of the network slices defined by the UE (100) and reselects the cell from the plurality of reordered cells. If the neighbor cell having the equal priority compared to the serving cell then, the UE (100) reorders priority of the plurality of cells having the equal priority based on the priority order of the network slices defined by the UE (100) and reselects the cell from the plurality of reordered cells.

Further, the UE (140) maps NSSAI to each of the serving cell and the neighbor cell using ‘a bit map with respect to each of the serving cell and the neighbor cell when the network slice information is received in the list of NSSAI’ and ‘an IE with each of the serving cell and the neighbor cell to the supported group of slices when the network slice information is received in the group of NSSAI lists’. The bit map can be of a size up to number of NSSAIs included in the list of NSSAIs. The IE includes each of the serving cell and the neighbor cell mapped to the group of NSSAI lists.

Further, the UE (100) determines that the mapping of the serving cell and the neighbor cell associated with frequency information shared by the serving cell and the neighbor cell. The frequency information comprises an allowed list cells from the plurality of cells and blocked list cells from the plurality of cells.

Further, the UE (100) determines whether the serving cell and the neighbor cell belongs to the allowed list cells or the blocked list cells. If the serving cell and the neighbor cell belongs to the allowed list cells then, the UE (100) detects the serving cell and the neighbor cell supports the network slice information. If the serving cell and the neighbor cell belongs to the blocked list cells then, the UE (100) detects the serving cell and the neighbor cell supports the network slice information.

Further, when wherein the network slice information is available from both SIB based broadcast and RRC Release message, the UE (100) uses RRC Release message based slice information and/or dedicated priority information until the timer T320 is running (after the timer T320 expiry, the SIB broadcast based slice info is used by the UE (100))

In another embodiment, if the cell is different from the previous RRC release message, the UE (100) uses the network slice information shared by the network entity (200) for prioritizing the cells for the selecting, camping and reselecting the cells

Further, the UE (100) determines the priority order of the plurality of cells based on the cell from the plurality of cells supporting a maximum number of ongoing network slices and the cell from the plurality of cells supporting a maximum number of interested slices.

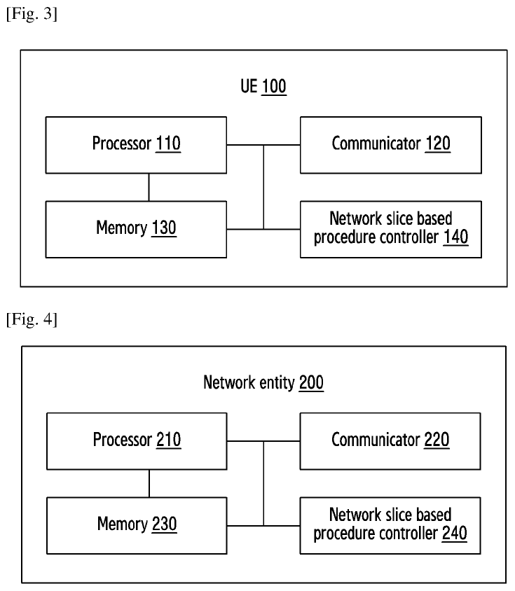

FIG. 3 shows various hardware components of the UE (100), according to an embodiment as disclosed herein. In an embodiment, the UE (100) includes a processor (110), a communicator (120), a memory (130) and a network slice based procedure controller (140). The processor (110) is coupled with the communicator (120), the memory (130), and the network slice based procedure controller (140).

The network slice based procedure controller (140) is configured to receive the network slice information of the plurality of network slices supported by the serving cell from the plurality of cells of the UE (100) and the one or more neighbor cell from the plurality of cells. In an embodiment, the network slice based procedure controller (140) is configured to send the UE assistance information comprising interested or desired slices details to the network entity (200) through the RRC message. Further, the network slice based procedure controller (140) is configured to receive the slice assistance configuration in the RRC reconfiguration from the network entity (200) based on that UE (100) needs to control and provide the slice assistance to the network entity (200).

In an embodiment, the network slice based procedure controller (140) is configured to reorder the plurality of cells based on the network slice information supported by the serving cell and the neighbor cell. Further, the network slice based procedure controller (140) is configured to measure the cell of the plurality of reordered cells based on the priority order of the plurality of cells and send the measurement report corresponding to the cell to the serving cell.

In an embodiment, the network slice based procedure controller (140) is configured to detect whether the neighbor cell from the plurality of cells meets the neighbor cell reporting criteria. If the neighbor cell from the plurality of cells meets the neighbor cell reporting criteria then, the network slice based procedure controller (140) is configured to detect whether multiple neighbor cells are meeting a multiple neighbor cells reporting criteria. In an embodiment, if multiple neighbor cells are meeting the multiple neighbor cells reporting criteria then, the network slice based procedure controller (140) is configured to prioritize the plurality of network slices supporting an ongoing network slices, split the measurement report, and send the measurement report associated with the at least one cell to the serving cell. Alternately, if multiple neighbor cells are not meeting the multiple neighbor cells reporting criteria then, the network slice based procedure controller (140) is configured to send the measurement report corresponding to the cell to the serving cell.

In another embodiment, the network slice based procedure controller (140) is configured to determine a priority order of the network slices based on the network slice information supported by the plurality of cells and select the cell from the plurality of cells for camping based on the priority order of the network slices. In an embodiment, the network slice based procedure controller (140) is configured to determine the list of cells from the plurality of cells meeting the Scriteria. Further, the network slice based procedure controller (140) is configured to select the cell from the list of cells for camping based on at least one of previous registration, previous access to cells, cell supporting highest priority slice, cells supporting a maximum number of slices, strongest cell supporting at least one required slice, and strongest cell supporting the at least one higher priority required slice.

In another embodiment, the network slice based procedure controller (140) is configured to determine the priority order of the network slices based on the network slice information supported by the serving cell and the neighbor cell. Further, the network slice based procedure controller (140) is configured to reselect the cell from the plurality of cells based on the priority order of the network slices.

In an embodiment, the network slice based procedure controller (140) is configured to read information of the neighbor cell from the plurality of cells and determines whether the neighbor cell having the higher priority compared to the serving cell, the lower priority compared to the serving cell, and the equal priority compared to the serving cell.

If the neighbor cell having the higher priority compared to the serving cell then, the network slice based procedure controller (140) is configured to reorder priority of the plurality of cells having the higher priority based on the priority order of the network slices defined by the UE (100) and reselect the cell from the plurality of reordered cells.

If the neighbor cell having the lower priority compared to the serving cell then, the network slice based procedure controller (140) is configured to reorder the priority of the plurality of cells having the lower priority based on the priority order of the network slices defined by the UE (100) and reselect the cell from the plurality of reordered cells. If the neighbor cell having the equal priority compared to the serving cell then, the network slice based procedure controller (140) is configured to reorder priority of the plurality of cells having the equal priority based on the priority order of the network slices defined by the UE (100) and reselects the cell from the plurality of reordered cells.

Further, the network slice based procedure controller (140) is configured to map the NSSAI to each of the serving cell and the neighbor cell using ‘the bit map with respect to each of the serving cell and the neighbor cell when the network slice information is received in the list of NSSAI’ and ‘the IE with each of the serving cell and the neighbour cell to the supported group of slices when the network slice information is received in the group of NSSAI lists.

Further, the network slice based procedure controller (140) is configured to determine that the mapping of the serving cell and the neighbor cell associated with frequency information shared by the serving cell and the neighbor cell. The frequency information includes the allowed list cells from the plurality of cells and blocked list cells from the plurality of cells.

Further, the network slice based procedure controller (140) is configured to determine whether the serving cell and the neighbor cell belongs to the allowed list cells or the blocked list cells. If the serving cell and the neighbor cell belongs to the allowed list cells then, the network slice based procedure controller (140) is configured to detect the serving cell and the neighbor cell supports the network slice information. If the serving cell and the neighbor cell belongs to the blocked list cells then, the network slice based procedure controller (140) is configured to detect the serving cell and the neighbor cell supports the network slice information.

Further, the network slice based procedure controller (140) configures the T320 timer. When the network slice information is available from both SIB based broadcast and RRC Release message, the UE (100) uses RRC Release message based slice information and/or dedicated priority information until the timer T320 is running (after the timer T320 expiry, the SIB broadcast based slice info is used by the UE (100))

Further, the network slice based procedure controller (140) is configured to determine whether the cell is same as previous RRC Release message is received and the T320 timer is still valid from the previous RRC Release message.

In an embodiment, if the cell is same as previous RRC release message and the T320 timer is still valid then, the network slice based procedure controller (140) is configured to use the network slice information shared by the network entity (200) for prioritizing the cells to camp on and to reselect shared by the network entity (200) for prioritizing cells for the selecting, camping and reselecting the cells

In another embodiment, if the cell is same as previous RRC release message and the T320 timer is not valid or stopped then, the network slice based procedure controller (140) is configured to use the dedicated priority and the T320 timer shared by the bestow in the previous RRC Release message or using by the UE (100) the slice network information shared by the network entity (200) for prioritizing the cells for the selecting, camping and reselecting the cells.

In another embodiment, if the cell is different from the previous RRC release message, the network slice based procedure controller (140) is configured to use the network slice information shared by the network entity (200) for prioritizing the cells for the selecting, camping and reselecting the cells

Further, the network slice based procedure controller (140) is configured to determine the priority order of the plurality of cells based on the cell from the plurality of cells supporting the maximum number of ongoing network slices and the cell from the plurality of cells supporting the maximum number of interested slices.

The network slice based procedure controller (140) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 3 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100). For example, the processor (110) may perform the functions of the network slice based procedure controller (140). Furthermore, the network slice based procedure controller (140) may be implemented by the processor (110).

FIG. 4 shows various hardware components of the network entity (200), according to an embodiment as disclosed herein. In an embodiment, the network entity (200) includes a processor (210), a communicator (220), a memory (230) and a network slice based procedure controller (240). The processor (210) is coupled with the communicator (220), the memory (230), and the network slice based procedure controller (240).

The network slice based procedure controller (240) is configured to configure a slice assistance configuration for the UE (100), send the slice assistance configuration in a RRC reconfiguration to the UE (100), and receive UE assistance information comprises interested or desired slices details from the UE (100) through a RRC message. The slice assistance configuration comprises network slice information and at least one of priority of slices or cells, a slice assistance periodic timer, a slice assistance prohibit timer, one or more triggers or events based on that the UE (100) needs to control and provide the slice assistance to the network entity (200);

The network slice based procedure controller (240) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 4 shows various hardware components of the network entity (200) but it is to be understood that other embodiments are not limited thereon. In other embodiments, the network entity (200) may include less or more number of components. Further, the labels or names of the components are used only for illustrative purpose and does not limit the scope of the invention. One or more components can be combined together to perform same or substantially similar function in the network entity (200). For example, the processor (210) may perform the functions of the network slice based procedure controller (240). Furthermore, the network slice based procedure controller (240) may be implemented by the processor (210).

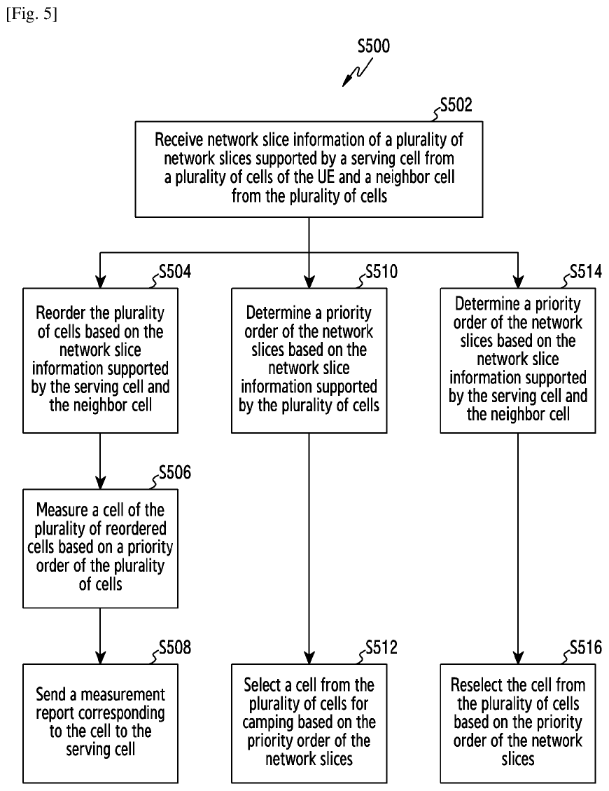

FIG. 5 is a flow chart (S500) illustrating a method, implemented by the UE (100), for provisioning the UE procedures for the network slicing, according to an embodiment as disclosed herein. The operations (S502-S516) are performed by the network slice based procedure controller (140).

At S502, the method includes receiving the network slice information of the plurality of network slices supported by the serving cell from the plurality of cells of the UE (100) and the neighbor cell from the plurality of cells. At S504, the method includes reordering the plurality of cells based on the network slice information supported by the serving cell and the neighbor cell. At S506, the method includes measuring the cell of the plurality of reordered cells based on the priority order of the plurality of cells. At S508, the method includes sending the measurement report corresponding to the cell to the serving cell.

At S510, the method includes determining the priority order of the network slices based on the network slice information supported by the plurality of cells. At S512, the method includes selecting the cell from the plurality of cells for camping based on the priority order of the network slices.

At S514, the method includes determining the priority order of the network slices based on the network slice information supported by the serving cell and the neighbor cell. At S516, the method includes reselecting the cell from the plurality of cells based on the priority order of the network slices.

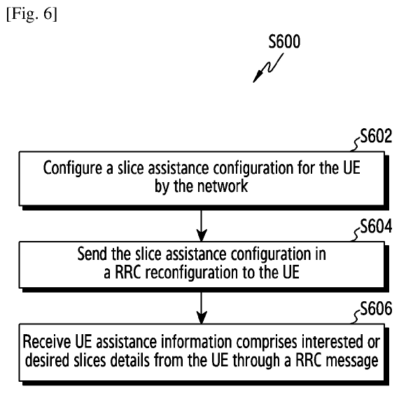

FIG. 6 is a flow chart (600) illustrating a method, implemented by the network entity (200), for provisioning the UE procedures for the network slicing, according to an embodiment as disclosed herein. The operations (S602-S606) are performed by the network slice based procedure controller (240).

At S602, the method includes configuring the slice assistance configuration for the UE by the network entity (200). At S604, the method includes sending the slice assistance configuration in the RRC reconfiguration to the UE (100). At S606, the method includes receiving the UE assistance information comprising interested or desired slices details from the UE (100) through the RRC message.

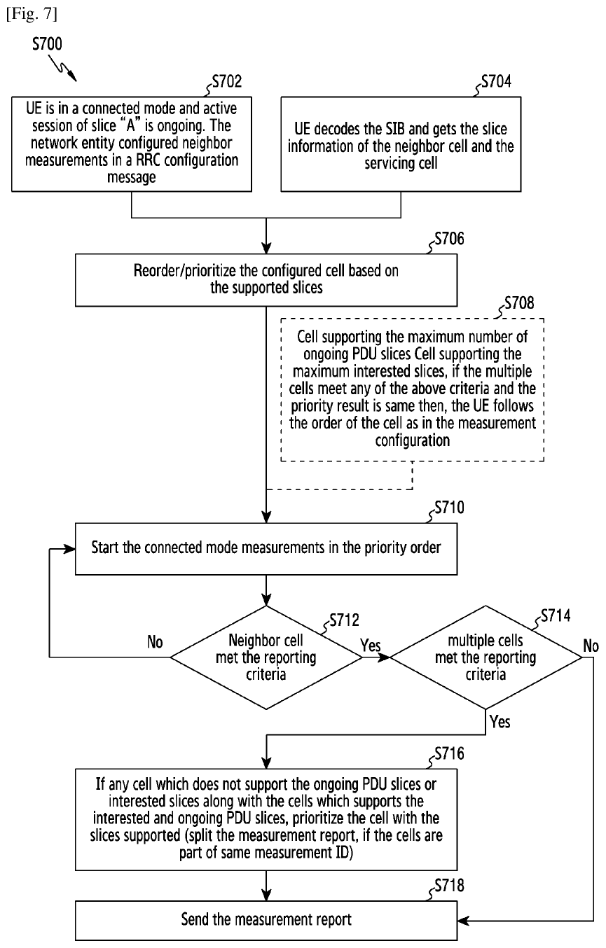

FIG. 7 illustrates (S700) a mobility scenario when the UE (100) is a connected mode, according to the embodiments as disclosed herein. It is applicable for the normal connected mode measurements as well as the condition handover (CHO) cases.

At S702, the UE (100) is in the connected mode and actives session of slice “A” is ongoing. The network entity (200) configured the neighbor measurements in the RRC configuration message. At S704, the UE (100) decodes the SIB and obtains the slice information of the neighbor cell and the servicing cell. At S706, the UE (100) reorders/prioritizes the configured cell based on the supported slices.

At S708, the cell supports the maximum number of ongoing PDU slices. The cell supports the maximum interested slices, if the multiple cells meet any of the above criteria and the priority result is same then, the UE (100) follows the order of the cell as in the measurement configuration.

At S710, the UE (100) starts the connected mode measurements in the priority order. At S712, the neighbor cell met the reporting criteria. At S714, the multiple cells met the reporting criteria. At S716, if any cell which does not support the ongoing PDU slices or interested slices along with the cells which supports the interested and ongoing PDU slices, prioritize the cell with the slices supported (split the measurement report, if the cells are part of same means ID). At S718, the UE (100) sends the measurement report.

Referring to the FIG. 7, the proposed method uses the slice information shared by the network entity (200) to prioritize the measurement reporting. Consider the measurements configured by the network entity (200), when multiple cells meet the measurement reporting criteria, the UE (100) may prioritize the cells which are supporting the desired slices and/or split the measurement reports accordingly and send measurement report to the network entity (200). When the UE (100) is in connected mode and neighbor cells are configured, the UE (100) may use the slice information shared by the network entity (200) to prioritize the measurements and reporting of neighbor cells. The priority of the cells may be determined by:
1. Cells supporting maximum number of ongoing PDU slices, and
2. Cells supporting maximum interested slices.

If the scenario needs to be controlled by network entity (200), the UE (100) will send the interested/desired slices to the network entity (200) through an existing RRC message (e.g.: UE assistance information). The network entity (200) may configure only the cells supporting these slices. The network entity (200) configures slice assistance in RRC reconfiguration under other config

```
  RRCReconfiguration-v17xx-IEs ::= SEQUENCE {otherConfig-v17xx
OtherConfig-v17xx
  OtherConfig-v17xx ::= SEQUENCE {slice-AssistanceConfig-r17
SetupRelease {slice-AssistanceConfig-r17}
  slice-AssistanceConfig-r17 ::= SEQUENCE
{slice-AssistanceConfig-r17 <slice details>
```

If network entity (200) wants to share the priority of cells to the UE (100) in connected mode, it may introduce the slice information and/or priority of slices/cells according to the UE interest along with the measurement configuration or as a separate IE, the UE (100) may also use this information in an idle mode (similar to dedicated priority probably with a timer value) when there is no dedicated priority configured by the network entity (200) is a RRC Release message.

If the UE (100) is configured with slice assistance configuration, the UE (100) may send the UE assistance information with the slice assistance details. The UE (100) may include the list of interested slices in this assistance information based on which network may be able to configure the measurements and decide on the target cell to which the device need to be handed over to

UE AssistanceInformation-v1540-IEs ::= SEQUENCE {
sliceAssistancesliceAssistance
sliceAssistance ::= SEQUENCE {
<slice details>

When configured with slice assistance configuration, the UE (100) sends the UE assistance information with the slice assistance details. The slice assistance configuration includes a slice assistance periodic timer and/or a slice assistance prohibit timer and/or one or more triggers/events based on that UE (100) needs to control and provide the slice assistance to the network entity (200). Every time slice assistance periodic timer expires and/or configured triggers/events occurs the UE (100) initiates slice assistance message. Triggers/events may include change of required slice(s) by the UE (100) e.g. when a new service is started or an existing service is terminated causing or UE's interest in service changes there is a change in slice(s) requirement, very first sending of the slice assistance once the UE (100) comes to the connected mode and/or completing handover and/or once the UE (100) gets in the RRC connected state and/or upon completion of handover and/or just before handover etc. The slice assistance periodic timer is started/restarted on timer expiry. However, the prohibit timer control the frequency of the message sending, by limiting the sending only when slice assistance prohibit timer is expired. The slice assistance prohibit timer is started/restarted when slice assistance is sent by the UE (100).

The major concern of including slice information in the SIB is the payload size. With the addition of supported slice(s) for serving cell and neighbor cell the size of SIB is going to be large. There is no proper method of slice representation and mapping to the frequencies/cells (both serving and neighbor) supported.

The proposed method introduces a SIB or uses any existing SIB to share the list of slices supported by the serving cell and neighbor cells(s) in an area (RA(s)). This can be of cell/area specific. The list can be represented in either of two ways—
1. Option 1: List of all NSSAIs {NSSAI1, NSSAI2 . . . NSSAIn}. n and
2. Option 2: Group of NSSAI lists {NSSAI GRP1 {NSSAI1, NSSAI2 . . . }, NSSAI GRP2 { }, . . . NSSAI GRPn { }}. n

The NSSAI mapping to a cell can be as below:
1. Mapping 1: A bit map (possibly the size of number of NSSAIs shared over SIB) with respect to each cell (serving & neighbor).
a) This is best suitable if Option 1 mentioned above is used.
2. Mapping 2: An IE with each neighbor cell to map the supported group of slices.
a) This is best suitable if Option 2 mentioned above is used.
b) Each value represented by the IE will map to the NSSAI GRP which will be have the list of all supported NSSAIs for that cell
c) Multiple cells may be mapped to the same NSSAI GRP based on the NSSAI support

In an embodiment, a possible structure for slice information list is shown as below:

FreqPriorityNRForSlicing-r17 ::= SEQUENCE {
carrierFreq ARFCN-ValueNR,
sliceInfoList SliceInfoList,
...
}
SliceInfoList-r17 ::= SEQUENCE (SIZE (1..maxSliceInfo-r17)) OF
SliceInfo
SliceInfo ::= SEQUENCE {
sliceGroupID-r17 FFS,
cellReselectionPriority CellReselectionPriority OPTIONAL, -- Need R
cellReselectionSubPriority CellReselectionSubPriority OPTIONAL, --
Need R
sliceCellListNR SliceCellListNR OPTIONAL, -- Need R
...
}
SliceCellListNR ::= SEQUENCE (SIZE (1..maxCellSlice)) OF
SliceCellInfoNR
SliceCellInfoNR ::= SEQUENCE {
physCellId PhysCellId,
...
}

For inter frequency neighbor cells, the network entity (200) shares the frequency information and possibly, the whitelist/allowed list cells in the frequency. If the NSSAI mapping is shared for a frequency, all cells belonging to the frequency (if no whitelist/allowed list is provided) will support the slices represented by the mapping. If whitelist/allowed list is present, then the cells present in whitelist/allowed list will support the slices represented by the mapping. The network entity (200) may add same frequencies multiple times with different cells in the whitelist/allowed list to differentiate the supported slices between cells in same frequencies.

If a frequency ‘A’ is configured with whitelist/allowed list and slice information, all the cells mentioned in the whitelist/allowed list will support the slices mapped to the configuration. With slice information all cells in the frequency will support these slices, without slice information al cells in the frequencies do not support any slices.

If a frequency ‘B’ is configured without any whitelist/allowed list and slice information is mapped, all cells in this frequency (except cells in blacklist/blocked list, if any) will support the slices mapped to the frequency. With slice information all cells in the frequency will support these slices, without slice information all cells in the frequencies do not support any slices.

If the frequency ‘A’ is present again without any whitelist/allowed list, with slice information all cells in the frequency except those already present in other configuration(s) will support these slices, without slice information all cells in the frequencies except those already present in other configurations do not support any slices.

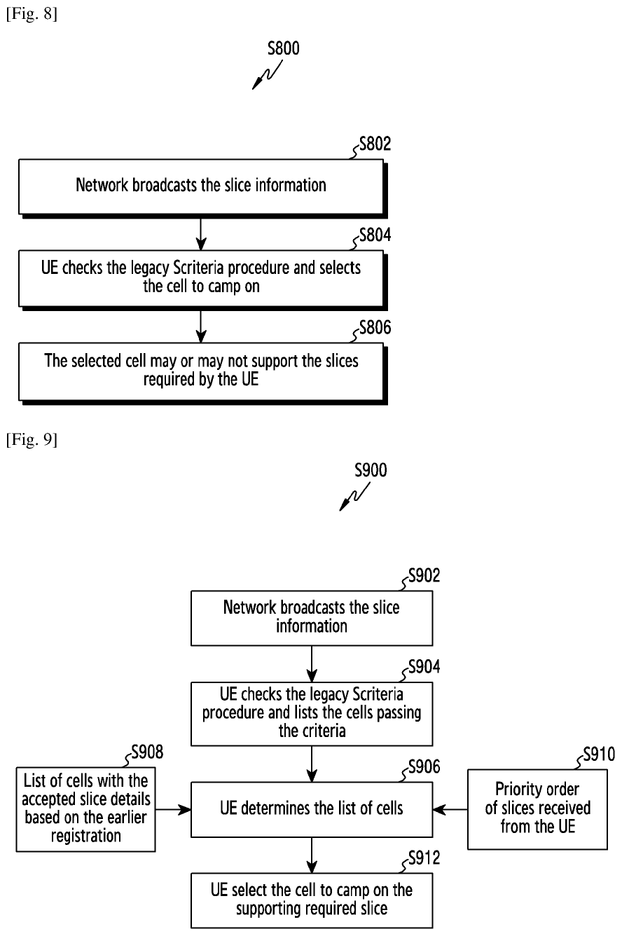

FIG. 8 illustrates (S800) the cell selection in the wireless network (1000). At 802, the network entity (200) broadcasts the slice information. At 804, the UE (100) checks the legacy Scriteria procedure and selects the cell came on. At 806, the selected cell may or may not support the slices required by the UE (100). In the conventional methods and systems, the current legacy cell selection does not consider the slice information broadcasted by the network (1000).

FIG. 9 illustrates (S900) a proposed cell selection in the wireless network (1000), according to the embodiments as disclosed herein.

At S902, the network entity (200) broadcasts the slice information. At S904, the UE (100) checks the legacy Scriteria procedure and lists the cells passing the criteria. At S906, the UE (100) determines the list of cells. At S908, the list of cells with the accepted slice details is provided based on the earlier registration. At S910, the priority order of slices is received from the UE (100). At S912, the UE (100) selects the cell to camp on the supporting required slice

Referring to the FIG. 9, in the proposed method, the UE (100) will search for the available cells and check the Scriteria. For those cells satisfying the Scriteria procedure, the UE (100) may check the availability of required slices in the cells and then select the cell to camp on. In order to check and apply the list of supported cells, the UE (100) may prioritize the interested slices in the decreasing order and uses the details/list of accepted slices when camped to the same cell earlier. To select a cell, the UE (100) may
1. Option 1: Select the cell supporting highest priority slice
a) If there are multiple cells supporting the highest priority slice, select the cell supporting maximum number of priority slices.
2. Option 2: Select the cell supporting maximum number of slices.
3. Option 3: Select the strongest cell which supports at least one required slice.
4. Option 4: Select the strongest cell which supports at least one higher priority required slice.

If the slice information is shared by the network entity (200) in the RRC release message for sharing the dedicated priority. The network entity (200) may also configure T320 timer for the validity of dedicated priority. If the UE (100) is moving to the idle mode without the RRC release message (e.g., data inactivity timer expiry, RLF etc.), the UE (100) may choose
1. If cell is same as previous RRC release message is received and T320 timer is still valid from the previous RRC release message (i.e., the UE (100) may choose not to stop the timer if the UE (100) move to connected mode again when the T320 is running), the UE (100) may continue to use the dedicated priority and restart T320 (or continue the existing timer) for validity or, the UE (100) may use the slice information shared by the network entity (200) for prioritizing cells to camp on and to reselect.
2. If the cell is same as previous RRC Release message is received and T320 timer is not valid (or stopped), the UE (100) may choose to use the dedicated priority and T320 timer shared by the network entity (200) in the previous RRC Release message or, the UE (100) may use the slice information shared by the network entity (200) for prioritizing cells to camp on and to reselect
3. If the cell is different when compared to the cell in which RRC Release message is received, the UE (100) may use the slice information shared by the network entity (200) for prioritizing cells to camp on and to reselect.

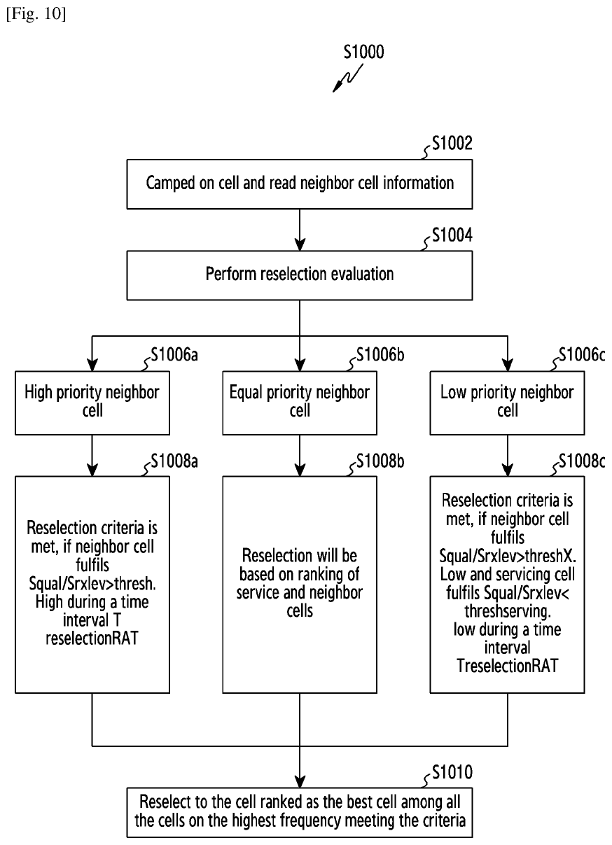

FIG. 10 illustrates (S1000) the cell reselection in the wireless network (1000). At S1002, the UE (100) is camped on the cell and reads the neighbor cell information. At S1004, the UE (100) performs the reselection evaluation. At 1006a, the UE (100) determines the high priority neighbor cell. At 1006b, the UE (100) determines the equal priority neighbor cell. At 1006c, the UE (100) determines the low priority neighbor cell. At 1008a, the UE (100) determines that the reselection criteria is met, if neighbor cell fulfils Squal/Srxlev>thresh. High during a time interval T_{reselectionRAT}. At 1008b, the UE (100) determines that the reselection will be based on ranking of service and neighbor cells. At 1008c, the UE (100) determines that the reselection criteria is met, if neighbor cell fulfils Squal/Srxlev>threshX. Low and servicing cell fulfils Squal/Srxlev<threshserving. Low during a time interval T_{reselectionRAT}. At 1010, the UE (100) reselects to the cell ranked as the best cell among all the cells on the highest frequency meeting the criteria.

Referring to the FIG. 10, in the conventional methods and systems, the existing reselection procedure checks only the priority of frequency set by network. This may not give cell specific prioritization and consideration for the preferred slices. As the slice priority depends on each UE, the network may not be able to prioritize the slices/cells based on the supported slices in a cell. Hence, just giving frequency priority may not serve the purpose when slice information is included in SIB.

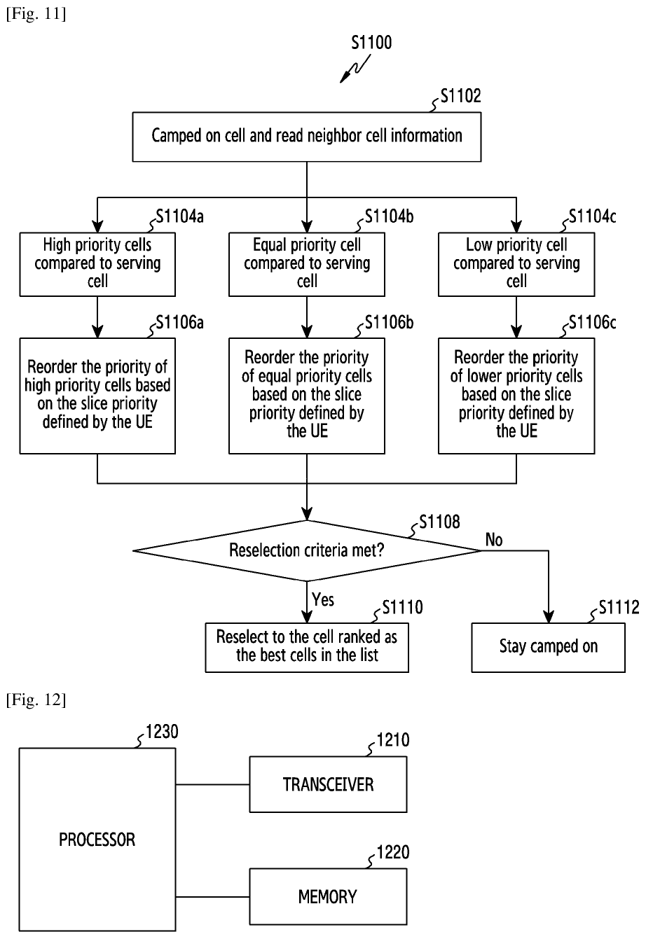

FIG. 11 illustrates (S1100) the cell reselection in the wireless network (1000), according to the embodiments as disclosed herein.

At S1102, the UE (100) is camped on the cell and reads the neighbor cell information. At S1104a, the UE (100) detects the high priority cells compared to the serving cell. At S1104b, the UE (100) detects the equal priority cell compared to the serving cell. At S1104c, the UE (100) detects the low priority cell compared to the serving cell.

At S1106a, the UE (100) reorders the priority of high priority cells based on the slice priority defined by the UE (100). At S1106b, the UE (100) reorders the priority of equal priority cells based on the slice priority defined by the UE (100). At S1106c, the UE (100) reorders the priority of lower priority cells based on the slice priority defined by the UE (100). At S1108, the UE (100) determines that whether the reselection criteria are met. If the reselection criteria are met then, at S1110, the UE (100) reselects to the cell ranked as the best cells in the list. If the reselection criteria are met then, at S1112, the UE (100) stays camped on.

Referring to the FIG. 11, in the proposed method, the UE (100) may maintain the priority of slices based on the interest and support. When neighbor cells are configured, the UE (100) may check the availability of required slices in the cells and prioritize the neighbor cells accordingly. In order to check and apply the list of supported cells, the UE (100) may prioritize the interested slices in the decreasing order and use the details/list of accepted slices when camped to the same cell earlier. Further, to prioritize a cell, the UE (100) may prioritize the cells based on the priority of supported slices and prioritize the cells in the order of maximum number of supporting slices. Dedicated priority may be used by the network entity (200).

In an embodiment, when there is no slice information or slice group information for reselection is provided to the UE, UE uses the legacy cell reselection information that is UE does not consider the slice priorities.

In another embodiment, the slice information of serving cell and neighboring cells are provided in the RRC release message and/or legacy dedicated priority information is provided in the RRC release message. However, there may be possible scenario when UE (100) is may not receive RRC Release message e.g. due to poor channel conditions causing decoding error to receive RRC Release. This may cause RRC state mismatch between the UE (100) and the network entity (200) and therefore, the UE (100) is required to locally release RRC connection and move to idle state.

For this purpose, dataInactivityTimer is operated to consider reception and/or transmission of MAC SDU on DCCH and/or DTCH and/or CCCH logical channels. If any MAC entity (which implies at least one of component carriers or serving cells and/or dual/multi connectivity cell-groups and/or serving cells) receives or transmits a MAC SDU, the dataInactivityTimer is started or restarted (i.e. if it is already started and running). When the dataInactivityTimer expires, it is indicated to the upper layer e.g. RRC or PDCP etc. For instance, when RRC receives this indication, it releases the RRC connection and transits UE (100) to the idle state.

As there is loss of slice information for serving cell and/or slice information for neighbor cells and/or legacy dedicated priority information, the proposed method provides following solutions to address the issue.
1. Option 1: the UE (100) utilizes the slice information for serving cell and/or slice information for neighbor cells and/or legacy dedicated priority information received in previous RRC release message
2. Option 1A: When this is the first RRC Release message
a) The UE (100) does not apply the slice prioritization and/or legacy dedicated prioritization
b) The UE (100) avails the slice information and/or prioritization information from broadcast signaling i.e. SIB
3. Option 2: the UE (100) utilizes the slice information for serving cell and/or slice information for neighbor cells and/or legacy dedicated priority information received in SIB.
4. Option 3: the UE (100) send the UE assistance information with the slice assistance before or after dataInactivityTimer expiry to the network entity (200).
5. Option 4: the UE (100) utilizes the stored slice information for the serving cell and/or slice information for neighbor cell and/or dedicated priority information.

In another embodiment, either one or both of RRC Release and SIB i.e. combination of RRC release and system information based slice information for serving cell and/or slice information for the neighbor cells and dedicated priority information and/or broadcasted priority information is used by the UE (100). In certain cases like initial access and Radio Link Failure (RLF), there may not be RRC Release and associated information then, the UE (100) can rely on broadcasted information.

The various actions, acts, blocks, steps, or the like in the flow charts (S500-S1100) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

FIG. 12 is a block diagram of an internal configuration of a base station, according to an embodiment.

As shown in FIG. 12, the base station according to an embodiment may include a transceiver 1210, a memory 1220, and a processor 1230. The transceiver 1210, the memory 1220, and the processor 1230 of the base station may operate according to a communication method of the base station described above. However, the components of the base station are not limited thereto. For example, the base station may include more or fewer components than those described above. In addition, the processor 1230, the transceiver 1210, and the memory 1220 may be implemented as a single chip. Also, the processor 1230 may include at least one processor.

The transceiver 1210 collectively refers to a base station receiver and a base station transmitter, and may transmit/receive a signal to/from a terminal. The signal transmitted or received to or from the terminal may include control information and data. The transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

Also, the transceiver 1210 may receive and output, to the processor 1230, a signal through a wireless channel, and transmit a signal output from the processor 1230 through the wireless channel.

The memory 1220 may store a program and data required for operations of the base station. Also, the memory 1220 may store control information or data included in a signal obtained by the base station. The memory 1220 may be a storage medium, such as read-only memory (ROM), random access memory (RAM), a hard disk, a CD-ROM, and a DVD, or a combination of storage media.

The processor 1230 may control a series of processes such that the base station operates as described above. For example, the transceiver 1210 may receive a data signal including a control signal transmitted by the terminal, and the processor 1230 may determine a result of receiving the control signal and the data signal transmitted by the terminal.

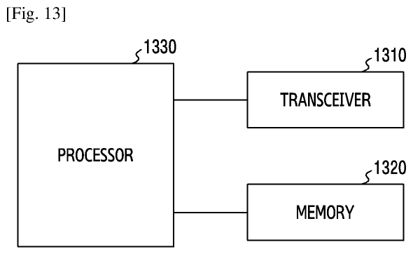

FIG. 13 is a block diagram showing an internal structure of a terminal, according to an embodiment of the present disclosure. As shown in FIG. 13, the terminal of the present disclosure may include a transceiver 1310, a memory 1320, and a processor 1330. The transceiver 1310, the memory 1320, and the processor 1330 of the terminal may operate according to a communication method of the terminal described above. However, the components of the terminal are not limited thereto. For example, the terminal may include more or fewer components than those described above. In addition, the processor 1330, the transceiver 1310, and the memory 1320 may be implemented as a single chip. Also, the processor 1330 may include at least one processor.

The transceiver 1310 collectively refers to a terminal receiver and a terminal transmitter, and may transmit/receive a signal to/from a base station. The signal transmitted or received to or from the base station may include control information and data. In this regard, the transceiver 1310 may include a RF transmitter for up-converting and amplifying a frequency of a transmitted signal, and a RF receiver for amplifying low-noise and down-converting a frequency of a received signal. However, this is only an example of the transceiver 1310 and components of the transceiver 1310 are not limited to the RF transmitter and the RF receiver.

Also, the transceiver 1310 may receive and output, to the processor 1330, a signal through a wireless channel, and transmit a signal output from the processor 1330 through the wireless channel.

The memory 1320 may store a program and data required for operations of the terminal. Also, the memory 1320 may store control information or data included in a signal obtained by the terminal. The memory 1320 may be a storage medium, such as ROM, RAM, a hard disk, a CD-ROM, and a DVD, or a combination of storage media.

The processor 1330 may control a series of processes such that the terminal operates as described above. For example, the transceiver 1310 may receive a data signal including a control signal, and the processor 1330 may determine a result of receiving the data signal.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local area network (LAN), a wireless LAN (WLAN), or a storage area network (SAN), or a combination thereof. The storage device may be connected through an external port to an apparatus according the embodiments of the present disclosure. Another storage device on the communication network may also be connected to the apparatus performing the embodiments of the present disclosure.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims. Also, the embodiments may be combined with each other as required. For example, a base station and a terminal may operate with some of the methods proposed in the present disclosure combined together. Also, the embodiments are proposed based on a 5G or NR system, but other modifications based on technical ideas of the embodiments may be implemented on other systems, such as an LTE, LTE-A, LTE-A-Pro systems, 6G network and an O-RAN network.

1.-15. (canceled)

16. A method for a user equipment (UE), the method comprising:
receiving, from a base station, a priority information for network slicing based cell reselection including a network slice information list and frequency information associated with the network slice information list;
identifying a priority order of a plurality of network slices based on the priority information;
reselecting a cell based on the priority order of the plurality of network slices; and
camping on the selected cell,
wherein each of network slice information in the network slice information list includes network slice group identification (ID) information and cell reselection priority information.

17. The method of claim 16, wherein the priority information is received via at least one of a system information block (SIB) or a radio resource control (RRC) release message.

18. The method of claim 17, wherein, in case that the priority information is received via the SIB, the each of network slice information further includes at least one of an allowed cell list or a blocked cell list for the network slicing.

19. The method of claim 18, wherein, in case that network slice information does not include any cell list, all cells related with the frequency information support network slices related with network slice group ID information included in network slice information.

20. The method of claim 17, wherein the identifying of the priority order of the plurality of network slices comprises:
in case that the priority information is received via the SIB, identifying the priority order of the plurality of network slices based on the priority information received via the SIB; and
in case that the priority information is received via the RRC release message, starting a timer and identifying the priority order of the plurality of network slices based on the priority information received via the RRC release message.

21. The method of claim 20, wherein the identifying of the priority order of the plurality of network slices further comprises:
in case that the priority information is received via both of the SIB and the RRC release message, starting the timer and identifying the priority order of the plurality of network slices based on the priority information received via the RRC release message while the timer is running, and identifying the priority order of the plurality of network slices based on the priority information received via the SIB after expiry of the timer.

22. The method of claim 16, further comprising:
identifying a priority order of a plurality of cells based on at least one of a maximum number of ongoing network slices or a maximum number of interested slices.

23. The method of claim 22, further comprising:
performing measurements of the plurality of cells;
splitting measurement report based on the priority order of the plurality of cells; and
transmitting, to the base station, the split measurement report.

24. The method of claim 16, further comprising:
transmitting, to the base station, a UE assistance information including information on interested network slice via a radio resource control (RRC) message, and
wherein the network slice information is generated based on the UE assistance information.

25. A user equipment (UE) comprising:
a transceiver; and
at least one controller coupled with the transceiver configured to:
receive, from a base station, a priority information for network slicing based cell reselection including a network slice information list and frequency information associated with the network slice information list,
identify a priority order of a plurality of network slices based on the priority information,
reselect a cell based on the priority order of the plurality of network slices, and
camp on the selected cell,
wherein each of network slice information in the network slice information list includes network slice group identification (ID) information and cell reselection priority information.

26. The UE of claim 25, wherein the priority information is received via at least one of a system information block (SIB) or a radio resource control (RRC) release message.

27. The UE of claim 26, wherein, in case that the priority information is received via the SIB, the each of network slice information further includes at least one of an allowed cell list or a blocked cell list for the network slicing.

28. The UE of claim 27, wherein, in case that network slice information does not include any cell list, all cells related with the frequency information support network slices related with network slice group ID information included in network slice information.

29. The UE of claim 26, wherein the at least one controller is further configured to:
in case that the priority information is received via the SIB, identify the priority order of the plurality of network slices based on the priority information received via the SIB, and
in case that the priority information is received via the RRC release message, start a timer and identify the priority order of the plurality of network slices based on the priority information received via the RRC release message.

30. The UE of claim 29, wherein the at least one controller is further configured to:
in case that the priority information is received via both of the SIB and the RRC release message, start the timer and identify the priority order of the plurality of network slices based on the priority information received via the RRC release message while the timer is running, and identify the priority order of the plurality of network slices based on the priority information received via the SIB after expiry of the timer.

31. The UE of claim 25, wherein the at least one controller is further configured to:
identify a priority order of a plurality of cells based on at least one of a maximum number of ongoing network slices or a maximum number of interested slices.

32. The UE of claim 31, wherein the at least one controller is further configured to:
perform measurements of the plurality of cells,
split measurement report based on the priority order of the plurality of cells, and
transmit, to the base station, the split measurement report.

33. The UE of claim 25,
wherein the at least one controller is further configured to:
transmit, to the base station, a UE assistance information including information on interested network slice via a radio resource control (RRC) message, and
wherein the network slice information is generated based on the UE assistance information.
